(19) United States
(12) Patent Application Publication
(10) Pub. No.: US 2011/0199293 A1
(43) Pub. Date: Aug. 18, 2011

(54) MULTI-ORIENTATION HANDWRITING TRACE INPUT DEVICE AND METHOD FOR ROTATING ITS COORDINATE PLANE

(75) Inventors: Yingjian Liu, Beijing (CN); Honggang WANG, Beijing (CN); Bojun SONG, Beijing (CN)

(73) Assignee: HANWANG TECHNOLOGY CO., LTD., Beijing (CN)

(21) Appl. No.: 13/073,466

(22) Filed: Mar. 28, 2011

Related U.S. Application Data
(63) Continuation of application No. PCT/CN2009/074221, filed on Sep. 25, 2009.

(30) Foreign Application Priority Data
Sep. 28, 2008 (CN) 200810223388.6

(51) Int. Cl. G09G 5/00

(52) U.S. Cl. 345/156

(57) ABSTRACT

The present invention provides a multi-orientation handwriting trace input device and a method for rotating a coordinate plane thereof, and relates to the field of computer peripheral input devices. The device comprises a coordinate indicator and a data receiver, wherein the coordinate indicator enables trace input within a predefined coordinate plane of the data receiver. The device further comprises a data communication unit and a coordinate plane rotation unit. The data communication unit is provided the data receiver. A processor of the data receiver transfers operation state information of the data communication unit to the coordinate plane rotation unit. The coordinate plane rotation unit rotates the coordinate plane of the data receiver according to the received operation state information of the data communication unit. The present invention can be implemented in a simple and reliable way, and is easy for use by both right-handed and left-handed users. The present invention is adaptive for use at various angles and can find a wide range of applications.

### BACKGROUND OF THE INVENTION

1. Field of the Invention

The invention generally relates to the field of computer peripheral input devices, and more particularly, to a multi-orientation handwriting trace input device and a method for rotating its coordinate plane.

2. Description of the Prior Art

Trace input devices are an important kind of computer peripheral input devices. Among the trace input devices, coordinate input devices enable input of handwriting and are also applied in a plurality of fields such as drawing, art, advertisement, and bank, etc.

The function of the coordinate input devices has been continuously expanded in use and development. For example, Chinese patent CN2490642Y discloses a coordinate input device with keys, which allows inputting other operation commands via the keys on the surface of a handwriting tablet than handwriting and drawing. Further, Chinese patent application No. 200710062786.X discloses implementing the function of keys by touch control. However, keys of such coordinate input devices are usually arranged at one side (e.g. the left side) of the coordinate input devices. Such an arrangement is easy for use by right-handed users but is inconvenient for left-handed users.

Moreover, the coordinate system of existing coordinate input devices is based on an absolute coordinate system, which is defined on a premise that the width is larger than the length, and well corresponds to the typical input surface of handwriting and drawing. However, it does not well apply to handwriting input on manuscript paper or printing paper that has the width smaller than the length.

### SUMMARY OF THE INVENTION

An object of the present invention is to provide a multi-orientation handwriting trace input device and a method for rotating its coordinate plane, which are simple, reliable, and easy for use by both right-handed and left-handed users. The present invention is adaptive for use at various angles, and thus improves the flexibility of the device.

In order to achieve the above object, there is provided a multi-orientation handwriting trace input device, comprising a coordinate indicator and a data receiver, wherein the coordinate indicator enables trace input within a predefined coordinate plane of the data to receiver. The device further comprises a data communication unit and a coordinate plane rotation unit. The data communication unit is provided in the data receiver. A processor of the data receiver transfers operation state information of the data communication unit to the coordinate plane rotation unit. The coordinate plane rotation unit rotates the coordinate plane of the data receiver according to the received operation state information of the data communication unit.

Preferably, the data communication unit comprises at least two communication ports that are disposed at different sides of the data receiver and are connected in parallel.

Preferably, the communication ports are wired ports.

Preferably, the communication ports are wireless ports.

Preferably, the data communication unit comprises a signal control module, wherein the processor determines the operation state information of the data communication unit by detecting an output signal from the signal control module.

Preferably, based on the above solutions, the coordinate plane rotation unit is provided in a data processing device, which establishes communication with the data receiver via the data communication unit.

Preferably, based on the above solutions, the coordinate plane rotation unit is a hardware driver of the data processing device.

Preferably, the coordinate plane rotation unit is a system application program of the data processing device.

In order to achieve the above object, there is further provided a method for rotating a coordinate plane of a multi-orientation handwriting trace input device, comprising: obtaining operation state information of a data communication unit of a data receiver; obtaining use orientation information of the data receiver from the operation state information of the data communication unit; transmitting the use orientation information of the data receiver to a coordinate rotation unit; rotating the coordinate plane of the data receiver according to the obtained use orientation information of the data receiver and setting corresponding coordinate information by the coordinate rotation unit.

Preferably, the step of obtaining the operation state information of the data communication unit of the data receiver comprises detecting an output signal from a signal control module of the data communication unit and determining the operation state information of the data communication unit according to the level of the output signal by a processor of the data receiver.

In the present invention, the use orientation of the coordinate input device is determined by detecting the operation state information of the data communication unit, so as to determine whether or not to rotate the coordinate plane of the date receiver and reset the coordinate plane data. The present invention can be implemented in a simple and reliable way, and is easy for use by both right-handed and left-handed users. The present invention is adaptive for use at various angles and thus can find a wide range of applications.

### BRIEF DESCRIPTION OF THE DRAWINGS

Hereinafter, the present invention is explained in detail with reference to the drawings.

FIG. 1 is a schematic view showing a first embodiment of a multi-orientation handwriting trace input device where a coordinate plane of a handwriting tablet is rotated according to the present invention;

to FIG. 1a is a schematic view showing a coordinate plane of the handwriting tablet using a first interface 31;

FIG. 1b is a schematic view showing a coordinate plane of the handwriting tablet using a second interface 32 after being rotated by 180°;

FIG. 2 is a schematic view showing a second embodiment of a multi-orientation handwriting trace input device where a coordinate plane of a handwriting tablet is rotated according to the present invention;

FIG. 2a is a schematic view showing a coordinate plane of the handwriting tablet using the first interface 31;

FIG. 2b is a schematic view showing a coordinate plane of the handwriting tablet using a third interface 33 after being rotated by 90°;

FIG. 3 is a circuit diagram showing a third embodiment of a signal control module of a wired interface according to the present invention;

FIG. 4 is a circuit diagram showing a fourth embodiment of a signal control module of a wired interface according to the present invention; and

FIG. 5 is a flow chart showing a method for rotating the coordinate plane of the multi-orientation handwriting trace input device according to the present invention.

### REFERENCE SIGNS

1—handwriting tablet; 2—keys; 31—first interface; 32—second interface; 33—third interface; 34—fourth interface; 4—plug.

### DETAILED DESCRIPTION OF THE PREFERRED EMBODIMENTS

In practice, a handwriting trace input device used with a data processing device such as a computer is typically an electromagnetic handwriting tablet. Therefore, embodiments will be described by taking the electromagnetic handwriting tablet as an example. However, the present invention is not limited to the electromagnetic handwriting tablet is but can be also applied to various handwriting trace input devices.

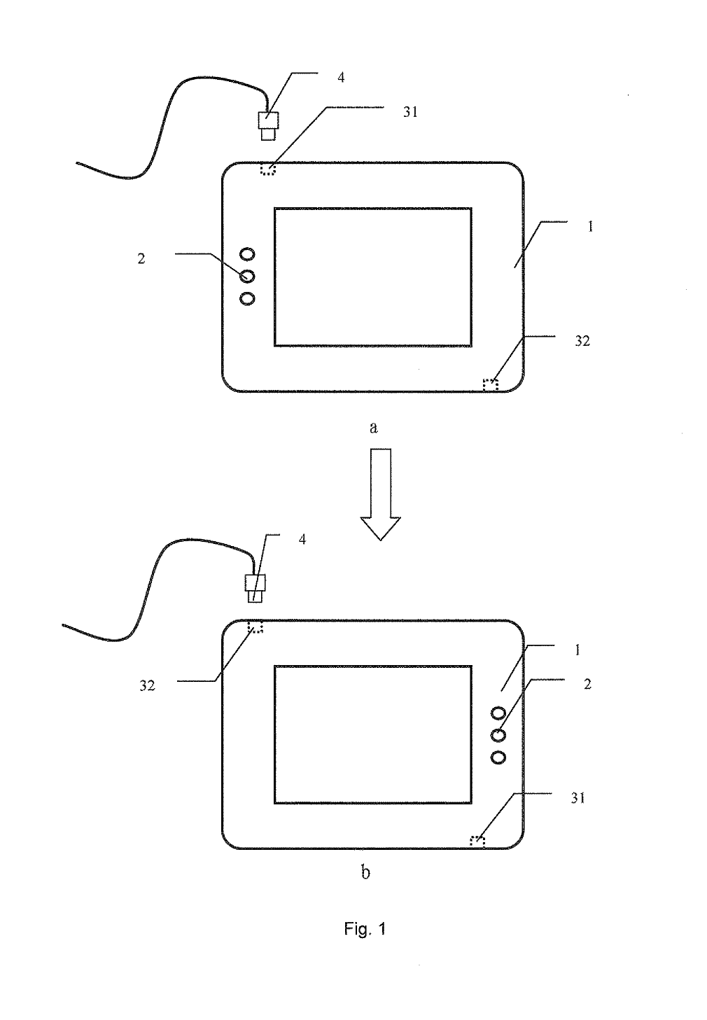

As shown in FIG. 1, a multi-orientation handwriting trace input device of the present invention comprises a handwriting tablet 1 as a data receiver, a coordinate indicator (not shown), a data communication unit and a coordinate rotation unit (not shown). The handwriting tablet 1 can generate and receive electric wave signals, and can be used together with the coordinate indicator to detect position information of the coordinate indicator in a predetermined coordinate plane and convert the position information into coordinate information. A coil arranged in the plane of the handwriting tablet 1 can transmit the electric wave signal and an inductance coil in the coordinate indicator generates a resonance signal. The coil in the handwriting tablet 1 then receives the resonance electric wave signal and obtains parameters such as position and pressure of the coordinate indicator in the plane by processing the signal.

The handwriting tablet 1 establishes communication with a computer via the data communication unit and transfers the coordinate information to the computer such that trace information of the writing by the coordinate indicator can be obtained;

In this embodiment, the data communication unit comprises communication ports such as wired or wireless interfaces, at least two in the number, disposed at a same side or different sides of the data receiver. Among the interfaces, the wired interfaces are connected in parallel. In this embodiment, there are 4 wired interfaces, including a first interface 31, a second interface 32, a third interface 33, and a fourth interface 34.

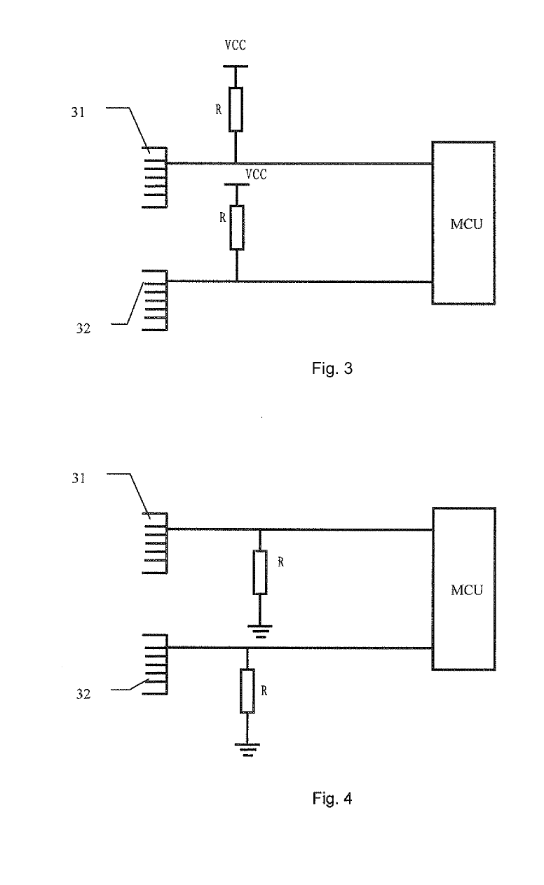

In this embodiment, each of the wired interfaces has a signal control module, which can be simple signal control means. The signal control module can be pull-up level control means shown in FIG. 3, or pull-down level control means shown in FIG. 4. A processor in the handwriting tablet 1 determines operation state information of the wired interfaces by detecting a level outputted from the signal control module. If a user feels uncomfortable with a current orientation of the handwriting tablet, he can use any other wired interface.

At this time the processor of the handwriting tablet 1 will detect a change in the operation state of the wired interfaces and then determine that the use orientation of the handwriting tablet has been changed. The processor transmits the use orientation information of the handwriting tablet to the coordinate rotation unit, which rotates the coordinate plane of the handwriting tablet accordingly and then sets the corresponding coordinate information. After the coordinate plane of the handwriting tablet is rotated, the position information of the coordinate indicator will be detected and calculated with reference to the rotated coordinate system.

FIG. 3 is a schematic view showing electric connections between the pull-up level control means and the processor. FIG. 4 is a schematic view showing electric connections between the pull-down level control means and the processor. As shown in FIG. 3, one end of a resistor R is connected to a high level VCC, and the other end thereof is connected to the first interface 31 and the processor, respectively. When the first interface 31 is connected, the processor detects that the output from the first interface 31 is at the high level. When the first interface 31 is switched to the second interface 32, the processor detects that the output from the second interface 32 is at the high level. The electric connections between the pull-down level control means and the processor shown in FIG. 4 is similar to those shown in FIG. 3.

The coordinate plane rotation unit is arranged in the data processing device, which is a computer in this embodiment. The rotation of the coordinate plane by the coordinate plane rotation unit can be implemented by automatically rotating the obtained coordinate to plane data or by an algorithm of matrix rotation in the coordinate plane triggered by software. The coordinate plane rotation unit may be a software driver program installed in the computer. The coordinate plane of the handwriting tablet is rotated by setting and changing parameters in the program. The coordinate plane rotation unit may also be a hardware driver program in the computer or a system application program.

In the first embodiment of the present invention, as shown in FIG. 1a, a plug 4 is plugged into the first interface 31, and the coordinate plane of the handwriting tablet is in a first state. When the plug 4 is plugged in to the second interface 32, as shown in FIG. 1b, the processor of the handwriting tablet 1 detects that the operation state of the communication ports is switched from the first interface 31 to the second interface 32, and then determines that the use orientation of the handwriting tablet 1 has been changed. The processor transmits information indicating the change of the operation state of the communication ports to the coordinate rotation unit. The coordinate rotation unit rotates the coordinate plane of the handwriting tablet by 180° from the first state to a second state after receiving the information transmitted from the processor. The coordinate information of the coordinate indicator (i.e. a handwriting stylus) on the handwriting tablet is then changed and set accordingly.

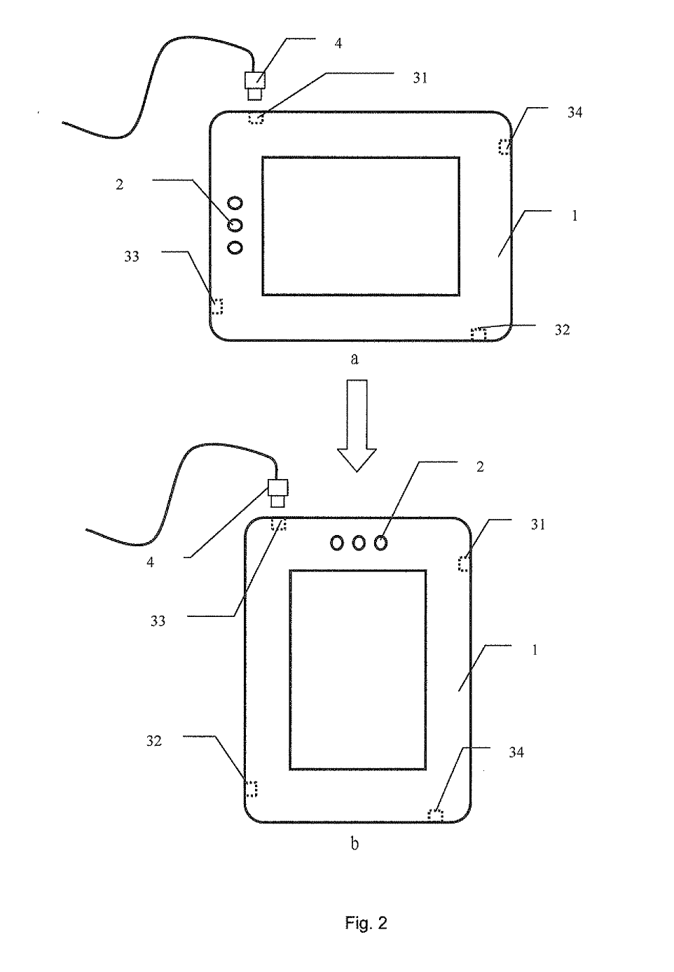

In a second embodiment of the present invention, as shown in FIG. 2, the handwriting tablet is rotated by 90° from an orientation shown in FIG. 2a where the first interface 31 is in use to an orientation shown in FIG. 2b where the third interface 33 is in use. The coordinate plane of the handwriting tablet is rotated by 90° accordingly. The coordinate information of the coordinate indicator is set and changed accordingly. Therefore, in order to obtain a best writing experience, the user can rotate the handwriting tablet at will to switch to any communication port of the handwriting tablet, and the coordinate plane of the handwriting plane will change in accordance with the change of the use orientation of the handwriting tablet.

According to the present invention, the communication ports may be wireless interfaces. When the wireless ports are being used, the wireless interfaces can be switched by means of hardware or software, to change the operation state information of the wireless interfaces. The use of the wireless interfaces can effectively avoid the reset and plug-in/pull-out which would arise for the wired interfaces, and thus is more convenient.

According to the present invention, control means (i.e. keys 2) is arranged on an upper surface of the handwriting tablet 1 to enable other functions such as Page Up/Page Down of the handwriting tablet. The keys 2 are arranged at a side of the upper surface of the handwriting tablet, for example, at middle of the side, to facilitate use thereof when the orientation is changed.

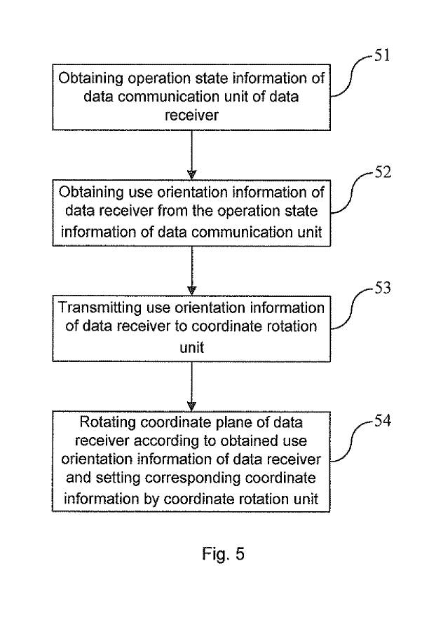

According to an embodiment of the present invention, there is also provided a method for rotating a coordinate plane of a multi-orientation handwriting trace input device. As shown in FIG. 5, the method comprises:

step 51: obtaining operation state information of a data communication unit of a data receiver;
step 52: obtaining use orientation information of the data receiver from the operation state information of the data communication unit;
step 53: transmitting the use orientation information of the data receiver to a coordinate rotation unit; and
step 54: rotating the coordinate plane of the data receiver according to the obtained use orientation information of the data receiver and setting corresponding coordinate information by the coordinate rotation unit. Then, the coordinate information of the coordinate indicator is determined in the new coordinate system.

In this embodiment, the step of obtaining the operation state information of the data communication unit of the data receiver particularly may comprise detecting an output signal from a signal control module of the data communication unit and determining the operation state information of the data communication unit according to the level of the output signal by a processor of the data receiver. As to details of the signal control module, reference may be made to the above description.

In the present invention, the use orientation of the coordinate input device is determined by detecting the operation state information of the data communication unit, so as to determine whether or not to rotate the coordinate plane of the date receiver and reset the coordinate plane data. The present invention can be implemented in a simple and reliable way, and is easy for use by both right-handed and left-handed users. The present invention is adaptive for use at various angles and can find a wide range of applications.

What is claimed is:

1. A multi-orientation handwriting trace input device, comprising a coordinate indicator and a data receiver, wherein the coordinate indicator enables trace input within a predefined coordinate plane of the data received, wherein:
the device further comprises a data communication unit and a coordinate plane rotation unit;
the data communication unit is provided in the data receiver;
a processor of the data receiver comprises a processor which transfers operation state information of the data communication unit to the coordinate plane rotation unit; and
the coordinate plane rotation unit rotates the coordinate plane of the data receiver according to the received operation state information of the data communication unit.

2. The multi-orientation handwriting trace input device according to claim 1, wherein the data communication unit comprises at least two communication ports connected in parallel, the at least two communication ports are disposed at a same side or different sides of the data receiver.

3. The multi-orientation handwriting trace input device according to claim 2, wherein the communication ports are wired or wireless ports.

4. The multi-orientation handwriting trace input device according to claim 1, wherein the data communication unit comprises a signal control module, and the processor determines the operation state information of the date communication unit by detecting an output signal from the signal control module.

5. The multi-orientation handwriting trace input device according to claim 1, wherein the coordinate plane rotation unit is provided in a data processing device, which establishes communication with the data receiver via the data communication unit.

6. The multi-orientation handwriting trace input device according to claim 5, wherein the coordinate plane rotation unit is a hardware driver of the data processing device.

7. The multi-orientation handwriting trace input device according to claim 5, wherein the coordinate plane rotation unit is a system application program of the data processing device.

8. A method for rotating the coordinate plane of the multi-orientation handwriting trace input device comprising a coordinate indicator and a data receiver, comprising:
providing a data communication unit and a coordinate plane rotation unit to the data receiver;
obtaining operation state information of the data communication unit of the data receiver;
obtaining use orientation information of the data receiver from the operation state information of the data communication unit;
transmitting the use orientation information of the data receiver to the coordinate rotation unit; and
rotating the coordinate plane of the data receiver according to the obtained use orientation information of the data receiver and setting corresponding coordinate information by the coordination rotation unit.

9. The method for rotating according to claim 8, wherein the step of obtaining the operation state information of the data communication unit of the data receiver comprises:
detecting an output signal from a signal control module of the data communication unit and determining the operation state information of the data communication unit according to the level of the output signal by a processor of the data receiver.
